(19) United States
(12) Patent Application Publication
(10) Pub. No.: US 2026/0162543 A1
(43) Pub. Date: Jun. 11, 2026

(54) ADVANCED AVIONICS FUNCTIONALITY FACILITATION IN LEGACY AIRCRAFT

(71) Applicant: Honeywell International Inc., Charlotte, NC (US)

(72) Inventors: Kirupakar J, Phoenix, AZ (US); Saurabh Jindal, Phoenix, AZ (US); Robert Son, Phoenix, AZ (US); Devi Padhy, Bangalore (IN); Kalimulla Khan, Bangalore (IN); Saravana Samy, Madurai (IN)

(21) Appl. No.: 19/170,059

(22) Filed: Apr. 4, 2025

(30) Foreign Application Priority Data
Dec. 9, 2024 (IN) 202411097103

(51) Int. Cl. G08G 5/34; G08G 5/32

(52) U.S. Cl. CPC G08G 5/34; G08G 5/32

(57) ABSTRACT

Techniques for facilitating advanced avionics functionality in legacy aircrafts are described. In operation, a flight data request is created in a first format for receiving at least avionics data from an avionics system of an aircraft. The flight data request is then converted into a modified flight data request in the second format. The modified fight data request is then communicated to the avionics system. A flight data response is received from the avionics system in response to the modified flight data request, where the flight data response is received in the second format and comprises at least the avionics data. The flight data response is then converted from the second format into the first format. Subsequently, at least the avionics data is utilized during the operation of the aircraft.

### BACKGROUND

Connectivity has emerged as a critical factor in modern aviation, revolutionizing flight operations and offering substantial improvements across multiple facets of aircraft management and control. The integration of advanced connectivity solutions has become a cornerstone for enhancing safety, efficiency, and overall operational effectiveness in the aviation industry. For instance, real-time data exchange allows pilots to access up-to-date information on weather patterns, air traffic, and potential hazards, enhancing their ability to make informed decisions. Further, connectivity enables dynamic route adjustments based on current flight route conditions, leading to fuel savings, reduced flight times, and improved on-time performance. Furthermore, seamless connectivity between pilots, air traffic control, and ground operations facilitates better coordination, reducing miscommunications and improving overall aircraft safety. Moreover, continuous monitoring and data transmission allow for early detection of potential mechanical issues, reducing unscheduled maintenance and improving aircraft reliability.

### SUMMARY

According to a first aspect, a method for facilitating advanced avionics functionality in legacy aircrafts is described. The method comprises: creating a flight data request in a first format for receiving at least avionics data from an avionics system of an aircraft, where a computing device other than the avionics system is compliant with the first format, and the avionics system is compliant with a second format; converting the flight data request into a modified flight data request in the second format, where the flight data request is to be communicated to the avionics system; communicating the modified fight data request to the avionics system; receiving a flight data response from the avionics system in response to the modified flight data request, where the flight data response is received in the second format and comprises at least the avionics data; converting the flight data response from the second format into the first format; and utilizing at least the avionics data during the operation of the aircraft.

According to some examples, the flight data request comprises at least one first data packet, and converting the flight data request into the modified flight data request comprises modifying a source field in a header of the at least one first data packet to include an identifier of the computing device.

According to some examples, the method further comprises generating a flight plan for the aircraft using at least the avionics data, where the flight plan is generated in the first format; converting the flight plan into a modified flight plan in the second format, where the modified flight plan is to be communicated to a Flight Management System (FMS) of the aircraft; and communicating the modified flight plan to the FMS via the avionics system.

According to some examples, the flight plan comprises at least one second data packet, and converting the flight plan into the modified flight plan comprises modifying a source field in a header of the at least one second data packet to include an identifier of the computing device.

According to some examples, the second format corresponds to Aeronautical Radio Incorporated (ARINC) 619 protocol.

According to some examples, the avionics system is a Communication Management Unit (CMU) of the aircraft.

According to a second aspect, an Aircraft Connectivity System (ACS) is described. The ACS comprises: a communication engine to receive, from a computing device other than an avionics system of an aircraft, a modified flight data request for transmitting at least avionics data of the aircraft, wherein the computing device is compliant with a first format and the avionics system is compliant with a second format, and the modified flight data request is received in the second format; an analysis engine coupled to the communication engine to parse the modified flight data request to determine that the modified flight data request is to be communicated to an FMS of the aircraft; and a data processing engine coupled to the analysis engine to: communicate the modified flight data request to the FMS; receive at least the avionics data in response to the modified flight data request; create a flight data response comprising at least the avionics data, wherein the flight data response is created in the second format; and transmit the flight data response to the computing device for use during the operation of the aircraft.

According to some examples, the modified flight data request comprises at least one first data packet, and a source field in a header of the at least one first data packet comprises an identifier of the computing device.

According to some examples, the data processing engine is to transmit the flight data response to the computing device based on the identifier of the computing device.

According to some examples, to communicate the modified flight data request to the FMS, the data processing engine is to: identify at least a first standard FMS command corresponding to the modified flight data request, wherein at least the first standard FMS command is identified from a plurality of predefined standard FMS commands compliant with the FMS; generate a flight data query using at least the first standard FMS command; and communicate the flight data query to the FMS.

According to some examples, the communication engine is to receive a modified flight plan for the aircraft in the second format; and the data processing engine is to: identify at least a second standard FMS command corresponding to the modified flight plan, wherein at least the second standard FMS command is identified from a plurality of predefined standard FMS commands compliant with the FMS; generate a flight plan directive using at least the second standard FMS command; and communicate the flight plan directive to the FMS.

According to some examples, the modified flight plan comprises at least one second data packet and a source field in a header of the at least one second data packet comprises an identifier of the computing device.

According to some examples, the data processing engine is to transmit a flight plan directive acknowledgement to the computing device based on the identifier of the computing device, and the flight plan directive acknowledgement is indicative of successful upload of the flight plan directive onto the FMS.

According to some examples, the second format corresponds to ARINC 619 protocol.

According to a third aspect, a non-transitory computer readable medium comprising computer-readable instructions that when executed cause a processing resource of a computing device to facilitate advanced avionics functionality in legacy aircrafts is described. The instructions when executed cause the processing resource to: create a flight data request in a first format for receiving at least avionics data from an avionics system of an aircraft, wherein a computing device other than the avionics system is compliant with the first format, and the avionics system is compliant with a second format; convert the flight data request into a modified flight data request in the second format, wherein the flight data request is to be communicated to the avionics system; communicate the modified flight data request to the avionics system; receive a flight data response from the avionics system in response to the modified flight data request, wherein the flight data response is received in the second format and comprising at least the avionics data; convert the flight data response from the second format into the first format; and utilize at least the avionics data during the operation of the aircraft.

According to some examples, the flight data request comprises at least one first data packet, and to convert the flight data request into the modified flight data request, the instructions cause the processing resource to modify a source field in a header of the at least one first data packet to include an identifier of the computing device.

According to some examples, the instructions further cause the processing resource to: generate a flight plan for the aircraft using at least the avionics data, wherein the flight plan is generated in the first format; convert the flight plan into a modified flight plan in the second format, wherein the modified flight plan is to be communicated to an FMS of the aircraft; and communicate the modified flight plan to the FMS via the avionics system.

According to some examples, the flight plan comprises at least one second data packet, and to convert the flight plan into the modified flight plan, the instructions cause the processing resource to modify a source field in a header of the at least one second data packet to include an identifier of the computing device.

According to some examples, the second format corresponds to ARINC 619 protocol.

According to some examples, the avionics system is a CMU of the aircraft.

### BRIEF DESCRIPTION OF DRAWINGS

FIG. 1 illustrates an environment for facilitating advanced avionics functionality in legacy aircrafts, in accordance with an example of the present subject matter.

FIG. 2 illustrates schematics of a computing device for facilitating advanced avionics functionality in the legacy aircrafts, in accordance with an example of the present subject matter.

FIG. 3 illustrates schematics of an Aircraft Connectivity System (ACS) for facilitating advanced avionics functionality in the legacy aircrafts, in accordance with an example of the present subject matter.

FIG. 4 illustrates interaction between the computing device interacts with the ACS for facilitating advanced avionics functionality in the legacy aircrafts, in accordance with an example of the present subject matter.

FIG. 5 illustrates a method for facilitating advanced avionics functionality in the legacy aircrafts, in accordance with an example of the present subject matter.

FIG. 6 illustrates the method for facilitating advanced avionics functionality in the legacy aircrafts, in accordance with another example of the present subject matter.

FIG. 7 illustrates the method for facilitating advanced avionics functionality in the legacy aircrafts, in accordance with yet another example of the present subject matter.

FIG. 8 illustrates the method for facilitating advanced avionics functionality in the legacy aircrafts, in accordance with yet another example of the present subject matter.

FIG. 9 illustrates the method for facilitating advanced avionics functionality in the legacy aircrafts, in accordance with yet another example of the present subject matter.

FIG. 10 illustrates a non-transitory computer-readable medium for facilitating advanced avionics functionality in the legacy aircrafts, in accordance with an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

Modern aircraft employ a sophisticated array of technologies to ensure uninterrupted connectivity. For instance, modern aircraft are equipped with Satellite-based systems to provide global coverage, allowing communication even in remote areas. Further, in modern aircraft, Electronic Flight Bags (EFBs) connect to aircraft systems, giving pilots access to digital resources and real-time data. Furthermore, modern aircraft systems include digital datalink systems, such as Aircraft Communication Addressing and Reporting System (ACARS), to facilitate short message transmission between aircraft and ground stations and Automatic Dependent Surveillance-Broadcast (ADS-B) technology to broadcast real-time aircraft information for improved situational awareness. Moreover, modern aircraft are equipped with integrated modular avionics to enable seamless data exchange between various avionics systems.

Despite the availability of such advanced technologies, many airlines continue to operate fleets that include a significant number of legacy aircraft. Airlines continue to operate such fleets for various reasons. For instance, acquiring aircraft with modern avionics systems represents a substantial financial investment. Thus, airlines may choose to extend the service life of existing aircraft to manage capital expenditures. Further, airlines typically phase out older aircraft gradually, balancing operational needs with financial constraints, resulting in a mix of newer and older aircraft in their fleets. Moreover, legacy aircraft may still meet current safety and operational standards, allowing airlines to continue their use without immediate replacement.

However, such legacy aircraft typically operate with outdated avionics systems that were not engineered to accommodate the complex algorithms and data processing demands of advanced connectivity solutions. Such avionics systems lack the necessary computing power and software compatibility to run advanced applications without substantial modifications. As a result, the legacy aircraft are unable to fully leverage the benefits of real-time data exchange, advanced flight management systems, and optimized operational capabilities that connectivity enables in modern aircraft.

A viable approach to implement modern connectivity solutions in legacy aircraft is to upgrade older avionics systems with components capable of handling complex algorithms and advanced data processing. However, such upgrades present significant challenges. For instance, the integration of new hardware is a costly endeavour, requiring substantial financial investment. Further, such modifications require extensive recertification processes, including Type certification and Technical Standard Order (TSO) re-certification. Such regulatory requirements add further complexity and expense to the upgrade process, rendering such upgrades a significant challenge for operators of legacy aircraft.

According to examples of the present subject matter, techniques for facilitating advanced avionics functionality in legacy aircrafts are described.

In an example, a flight data request is created for receiving at least avionics data from an avionics system of an aircraft. The flight data request may be created on a computing device other than the avionics system and may be created in a first format. The computing device may be compliant with the first format and the avionics system may be compliant with a second format. In an example, the computing device may be an Electronic Flight Bag (EFB) and the avionics system may be a Communication Management Unit (CMU) onboard the aircraft.

The flight data request may then be converted into a modified flight data request in the second format, where the flight data request is to be communicated to the avionics system. The modified flight data request may then be communicated to the avionics system. In response to the modified flight data request, a flight data response may be received from the avionics system. The flight data response may be received in the second format and may include at least the avionics data.

The flight data response may then be converted from the second format into the first format. Subsequently, at least the avionics data may be utilized during the operation of the aircraft. For instance, at least the avionics data may be utilized for generating a flight plan for the aircraft. The flight plan may be generated in the first format. The flight plan may then be converted into a modified flight plan in the second format, where the modified flight plan is to be communicated to a Flight Management System (FMS) of the aircraft. The modified flight plan may then be communicated to the FMS via the avionics system.

By converting the flight data requests and responses between the first and second formats, the present subject matter enables data exchange between legacy avionics systems and computing devices with necessary computing power and software compatibility to run advanced aviation applications. As a result, the computing devices can utilize avionics data from the legacy avionics systems for modern aircraft operations and flight planning and transmit generated flight plans to the FMS onboard the legacy aircraft for use during aircraft operations of the legacy aircraft. Accordingly, the present subject matter facilitates implementation of advanced avionics functionality in legacy aircraft without requiring extensive and costly hardware upgrades or recertification processes.

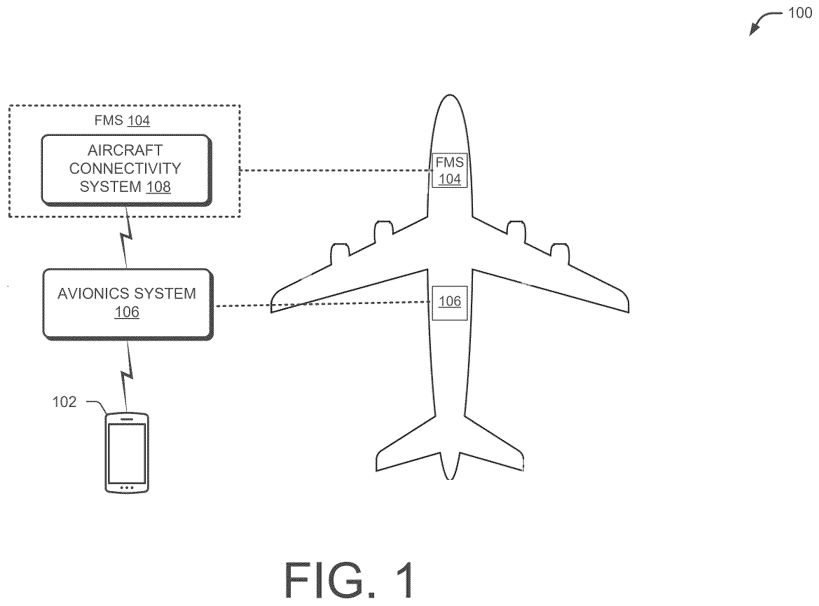

The above techniques are further described with reference to FIGS. 1 to 10. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates an environment 100 for facilitating advanced avionics functionality in legacy aircrafts, in accordance with an example of the present subject matter. In an example, the environment 100 may be an aircraft.

The environment 100 may include a computing device 102. The computing device 102 may have the necessary computing power and software compatibility to run advanced aviation applications for modern aircraft operations and flight planning. In an example, the computing device 102 may be an Electronic Flight Bag (EFB).

The environment 100 may further include a Flight Management System (FMS) 104 communicatively coupled to the computing device 102. In an example, the FMS 104 may be communicatively coupled to the computing device 102 via an avionics system 106, such as a Communication Management Unit (CMU), of the aircraft. In the example, the computing device 102 and the avionics system 106 may communicate with each other through a communication network (not shown). The communication network can be a wireless or a wired network, or a combination thereof. Further, the communication network can be a collection of individual networks, interconnected with each other and functioning as a single large network. Further, the FMS 104 and the avionics system 106 may communicate with each other via an avionics data bus (not shown) of the aircraft.

The FMS 104 may further include an Aircraft Connectivity System (ACS) 108 to facilitate communication between the computing device 102 and the FMS 104. The ACS 108 may facilitate communication between the computing device 102 and the FMS 104 by receiving various requests from the computing device 102 and communicate such requests to the FMS 104. In an example, upon receiving a request from the computing device 102, the ACS 108 may identify standard FMS commands corresponding to the request and communicate the identified standard FMS commands to the FMS 104. In an example, the ACS 108 may be implemented as part of firmware of the FMS 104.

In operation, the computing device 102 may create a flight data request for receiving at least avionics data from the avionics system 106. In an example, the computing device 102 may create the flight data request in a first format. In the example, the computing device 102 may be complaint with the first format and the avionics system 106 may be compliant with a second format. It would be noted that the first format and the second format may correspond to the communication formats supported by the computing device 102 and the avionics system 106, respectively.

The computing device 102 may then determine that the flight data request is to be communicated to the avionics system 106. Accordingly, the computing device 102 may convert the flight data request into a modified flight data request in the second format. The computing device 102 may then communicate the modified fight data request to the avionics system 106.

In an example, upon receiving the modified flight data request, the avionics system 106 may communicate the modified flight data request to the ACS 108. In the example, the ACS 108 may parse the modified flight data request to determine that the modified flight data request is to be communicated to the FMS 104. The ACS 108 may accordingly transmit the modified flight data request to the FMS 104. In response to the modified flight data request, the ACS 108 may receive at least the avionics data. The ACS 108 may then create a flight data response including at least the avionics data. The ACS 108 may create the flight data response in the second format. The ACS 108 may then transmit the flight data response to the avionics system 106. Subsequently, the avionics system 106 may communicate the flight data response to the computing device 102 for use during the operation of the aircraft.

Upon receiving the flight data response, the computing device 102 may convert the flight data response from the second format into the first format. The computing device may then utilize at least the avionics data during the operation of the aircraft. The manner in which the advanced avionics functionality is facilitated in the legacy aircrafts is further described in conjunction with the forthcoming figures.

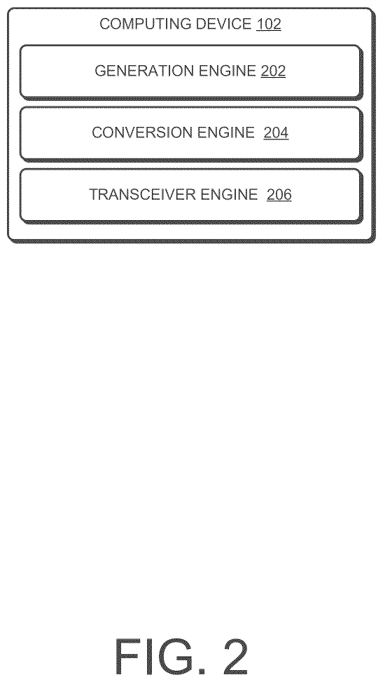

FIG. 2 illustrates schematics of the computing device 102, in accordance with an example of the present subject matter.

The computing device 102 may include a generation engine 202 to create the flight data request for receiving at least avionics data from the avionics system 106. In an example, the generation engine 202 may create the flight data request in the first format.

The computing device 102 may further include a conversion engine 204 coupled to the generation engine 202. The conversion engine 204 may convert the flight data request into the modified flight data request in the second format. In an example, the second format may correspond to Aeronautical Radio Incorporated (ARINC) 619 protocol.

The computing device 102 may further include a transceiver engine 206 coupled to the conversion engine 204. The transceiver engine 206 may communicate the modified fight data request to the avionics system 106.

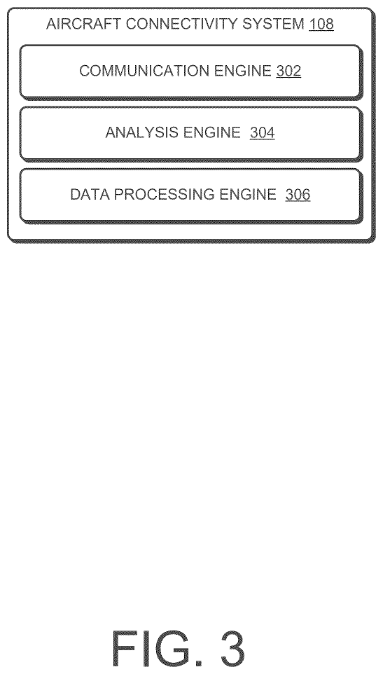

In an example, upon receiving the modified flight data request, the avionics system 106 may communicate the modified flight data request to the ACS 108. The manner in which the ACS 108 processes the modified flight data request is described in conjunction with FIG. 3.

In response to the modified flight data request, the transceiver engine 206 may receive the flight data response from the avionics system. In an example, the flight data response may be received in the second format and may include at least the avionics data. The conversion engine 204 may then convert the flight data response from the second format into the first format. The computing device 102 may then utilize at least the avionics data during the operation of the aircraft.

FIG. 3 illustrates schematics of the ACS 108, in accordance with an example of the present subject matter.

The ACS 108 may include a communication engine 302 to receive the modified flight data request. As already described, the modified flight data request may be received for transmitting at least avionics data of the aircraft and may be received in the second format.

The ACS 108 may further include an analysis engine 304 coupled to the communication engine 302. The analysis engine 304 may parse the modified flight data request to determine that the modified flight data request is to be communicated to the FMS 104.

The ACS 108 may further include a data processing engine 306 coupled to the analysis engine 304. In an example, upon determining that the modified flight data request is to be communicated to the FMS 104, the data processing engine 306 may communicate the modified flight data request to the FMS. In response to the modified flight data request, the data processing engine 306 may receive at least the avionics data. The data processing engine 306 may then create the flight data response including at least the avionics data, where the flight data response is created in the second format. The data processing engine 306 may then transmit the flight data response to the computing device 102 for use during the operation of the aircraft.

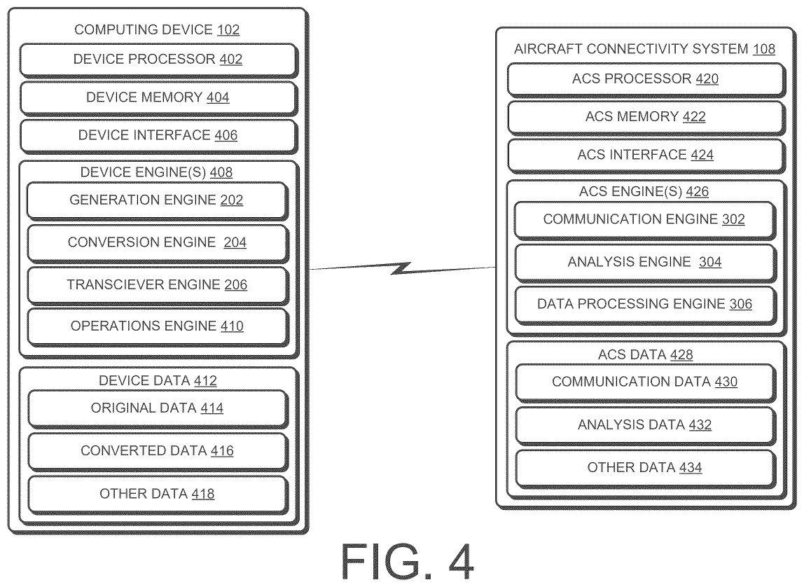

FIG. 4 illustrates interaction between the computing device 102 interacts with the ACS 108 for facilitating advanced avionics functionality in legacy aircrafts, in accordance with an example of the present subject matter.

As illustrated, the computing device 102 may include a device processor 402 and a device memory 404 coupled to the device processor 402. The functions of the various elements shown in the FIGs., including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, conventional and/or custom, may also be included.

The device memory 404 may include any computer-readable medium including, for example, volatile memory (e.g., RAM), and/or non-volatile memory (e.g., EPROM, flash memory, etc.).

The computing device 102 may further include a device interface 406. The device interface 406 may allow the connection or coupling of the computing device 102 with one or more other devices, through a wired (e.g., Local Area Network, i.e., LAN) connection or through a wireless connection (e.g., Bluetooth®, WiFi). The device interface 406 may also enable intercommunication between different logical as well as hardware components of the computing device 102.

The computing device 102 may further include device engine(s) 408, where the device engine(s) 408 may include the generation engine 202, the conversation engine 204, the transceiver engine 206, and an operations engine 410 coupled to the transceiver engine 206. In an example, the device engine(s) 408 may be implemented as a combination of hardware and firmware or software. In examples described herein, such combinations of hardware and firmware may be implemented in several different ways. For example, the firmware for the device engine(s) may be processor executable instructions stored on a non-transitory machine-readable storage medium and the hardware for the device engine(s) may include a processing resource (for example, implemented as either a single processor or a combination of multiple processors), to execute such instructions.

In the present examples, the machine-readable storage medium may store instructions that, when executed by the processing resource, implement the functionalities of the device engine(s). In such examples, the computing device 102 may include the machine-readable storage medium storing the instructions and the processing resource to execute the instructions. In other examples of the present subject matter, the machine-readable storage medium may be located at a different location but accessible to the computing device 102 and the device processor 402.

The computing device 102 may further include device data 412, that serves, amongst other things, as a repository for storing data that may be fetched, processed, received, or generated by the device engine(s) 408. The device data 412 may include original data 414, converted data 416, and other data 418. In an example, the device data 412 may be stored in the device memory 404.

Further, the ACS 108 may include an ACS processor 420 and an ACS memory 422 coupled to the ACS processor 420. The functions of the various elements shown in the FIGs., including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, conventional and/or custom, may also be included.

The ACS memory 422 may include any computer-readable medium including, for example, volatile memory (e.g., RAM), and/or non-volatile memory (e.g., EPROM, flash memory, etc.).

The ACS 108 may further include an ACS interface 424. The ACS interface 424 may allow the connection or coupling of the ACS 108 with one or more other devices, through a wired (e.g., Local Area Network, i.e., LAN) connection or through a wireless connection (e.g., Bluetooth®, WiFi). The ACS interface 424 may also enable intercommunication between different logical as well as hardware components of the ACS 108.

The ACS 108 may further include ACS engine(s) 426, where the ACS engine(s) 426 may include the communication engine 302, the analysis engine 304, and the data processing engine 306. In an example, the ACS engine(s) 426 may be implemented as a combination of hardware and firmware or software. In examples described herein, such combinations of hardware and firmware may be implemented in several different ways. For example, the firmware for the ACS engine(s) may be processor executable instructions stored on a non-transitory machine-readable storage medium and the hardware for the ACS engine(s) may include a processing resource (for example, implemented as either a single processor or a combination of multiple processors), to execute such instructions.

In the present examples, the machine-readable storage medium may store instructions that, when executed by the processing resource, implement the functionalities of the ACS engine(s). In such examples, the ACS 108 may include the machine-readable storage medium storing the instructions and the processing resource to execute the instructions. In other examples of the present subject matter, the machine-readable storage medium may be located at a different location but accessible to the ACS 108 and the ACS processor 420.

The ACS 108 may further include ACS data 428, that serves, amongst other things, as a repository for storing data that may be fetched, processed, received, or generated by the ACS engine(s) 426. The ACS data 428 may include communication data 430, analysis data 432, and other data 434. In an example, the ACS data 428 may be stored in the ACS memory 422.

In operation, the generation engine 202 may determine that a flight plan for the aircraft is to be generated. The generation engine 202 may determine that the flight plan is to be generated in various situations. For instance, the generation engine 202 may determine that the flight plan is to be generated when a new destination is inputted by a pilot or when there is a change in weather conditions along the current flight path. In some cases, the generation engine 202 may determine that a new flight plan is needed when there are airspace restrictions or when air traffic control requests a route change. The generation engine 202 may also initiate flight plan generation at regular intervals during a flight to optimize the route based on updated information. Additionally, the generation engine 202 may determine that a new flight plan is necessary when there are changes in aircraft performance parameters, such as fuel consumption rates or equipment malfunctions.

The generation engine 202 may accordingly create the flight data request for receiving at least avionics data from the avionics system 106. As already described, the avionics system 106 may be the CMU of the aircraft. In an example, the generation engine 202 may create the flight data request in the first format. As already described, the computing device 102 may be complaint with the first format and the avionics system 106 may be compliant with a second format.

The conversion engine 204 may then convert the flight data request into the modified flight data request in the second format. The modified flight data request may include at least a first data packet. In an example, to convert the flight data request into the modified flight data request, the conversion engine 204, among other things, may modify a source field in a header of at least the first data packet to include an identifier of the computing device 102. In the example, the conversion engine 204 may further modify a destination field in the header of at least the first data packet to include an identifier of the FMS 104. The transceiver engine 206 may then communicate the modified fight data request to the avionics system 106.

The communication engine 302 may then receive the modified flight data request from the computing device 102. The communication engine 302 may then store the modified flight data request in the communication data 430. Subsequently, the analysis engine 304 may parse the modified flight data request. The analysis engine 304 may parse the modified flight data request to determine, among other things, the source and the destination of the modified flight data request. The analysis engine 304 may then store the modified flight data request, along with the identifier of the computing device 102 and the identifier of the FMS 104, in the analysis data 432.

Based on the determination, the data processing engine 306 may communicate the modified flight data request to the FMS 104. In an example, to communicate the modified flight data request to the FMS 104, the data processing engine 306 may identify at least a first standard FMS command corresponding to the modified flight data request. In the example, at least the first standard FMS command may be identified from the plurality of predefined standard FMS commands compliant with the FMS 104. The ACS 108 may maintain a library of the standard FMS commands and functions corresponding to the standard FMS commands in the other data 434. When a modified flight data request or a modified flight data request is received, the data processing engine 306 may analyse the modified flight data request to determine the appropriate standard FMS commands to use. For example, if the modified flight data request is seeking information about the current route, the data processing engine 306 may identify a route query command from its library of standard FMS commands.

The data processing engine 306 may then generate a flight data query using at least the first standard FMS command. The data processing engine 306 may generate a flight data query using at least the first standard FMS command. Subsequently, the data processing engine 306 may communicate the flight data query to the FMS 104.

In an example, upon receiving the flight data query, the FMS 104 may collect at least the avionics data from the various avionics systems onboard the aircraft. In the example, the FMS 104 may then transmit at least the avionics data to the ACS 108.

The data processing engine 306 may then receive at least the avionics data and store at least the avionics data in the other data 434. Thereafter, the data processing engine 306 may create the flight data response including at least the avionics data. In an example, the flight data response may be created in the second format. The data processing engine 306 may then transmit the flight data response to the computing device 102 in response to the modified flight data request. In the example, the data processing engine 306 may transmit the flight data response to the computing device 102 based on the identifier of the computing device 102.

The transceiver engine 206 may then receive the flight data response from the ACS 108. The flight data response may be received in the second format and may include at least the avionics data. Accordingly, the conversion engine 204 may convert the flight data response into the first format. The conversion engine 204 may then store the flight data response including at least the avionics data in the converted data 416.

Subsequently, the operations engine 410 may utilize at least the avionics data during the operation of the aircraft. For instance, the operations engine 410 may utilize at least the avionics data to generate a flight plan for the aircraft. The operations engine 410 may generate the flight plan in the first format. The operations engine 410 may then store the flight plan in the original data 414.

The conversion engine 204 may then convert the flight plan into a modified flight plan in the second format. The flight plan may include at least a second data packet. In an example, to convert the flight plan into the modified flight plan, the conversion engine 204 may, among other things, modify a source field in a header of at least the second data packet to include an identifier of the computing device 102. In the example, the conversion engine 204 may further modify a destination field in a header of at least the second data packet to include an identifier of the FMS 104. The transceiver engine 206 may then communicate the modified flight plan to the FMS 104 via the avionics system 106.

The communication engine 302 may then receive the modified flight plan for the aircraft in the second format. The communication engine 302 may then store the receive the modified flight plan in the communication data 430. Subsequently, the analysis engine 304 may parse the modified flight plan request. The analysis engine 304 may parse the modified flight plan request to determine, among other things, the source and the destination of the modified flight plan request. The analysis engine 304 may then store the modified flight plan request, along with the identifier of the computing device 102 and the identifier of the FMS 104, in the analysis data 432.

The data processing engine 306 may then identify at least a second standard FMS command corresponding to the modified flight plan. The data processing engine 306 may identify at least the second standard FMS command from a plurality of predefined standard FMS commands compliant with the FMS. Subsequently, the data processing engine 306 may generate a flight plan directive using at least the second standard FMS command. The data processing engine 306 may then communicate the flight plan directive to the FMS 104.

In an example, the data processing engine 306 may then transmit a flight plan directive acknowledgement to the computing device 102. The flight plan directive acknowledgement may be indicative of successful upload of the flight plan directive onto the FMS 104. The data processing engine 306 may transmit the flight plan directive acknowledgement to the computing device 102 based on the identifier of the computing device 102.

By converting the flight data requests and responses between the first and second formats, the present subject matter enables data exchange between legacy avionics systems and computing devices, such as the computing device 102, with necessary computing power and software compatibility to run advanced aviation applications. As a result, the computing devices can utilize avionics data from the legacy avionics systems for modern aircraft operations and flight planning and transmit generated flight plans to the FMS onboard the legacy aircraft for use during aircraft operations of the legacy aircraft.

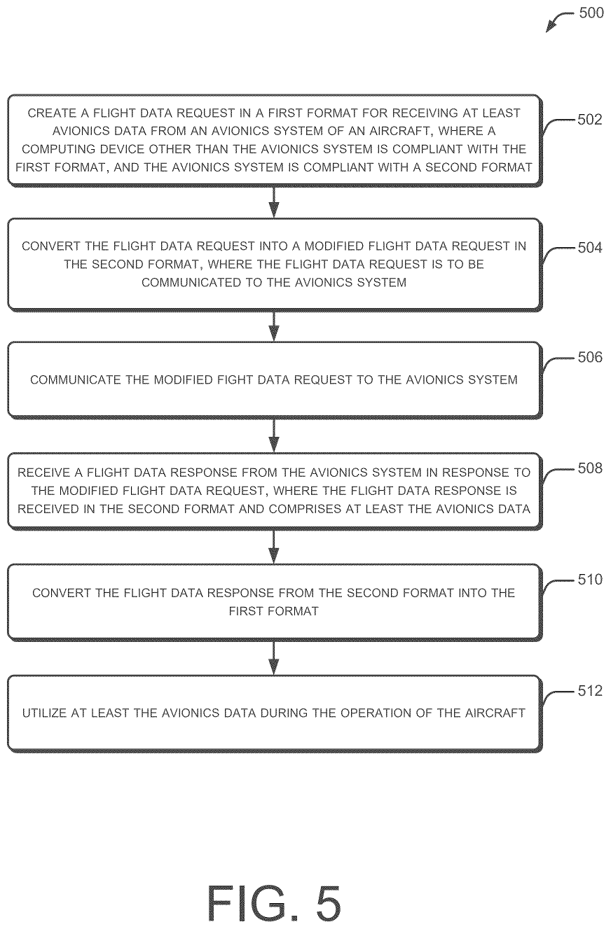

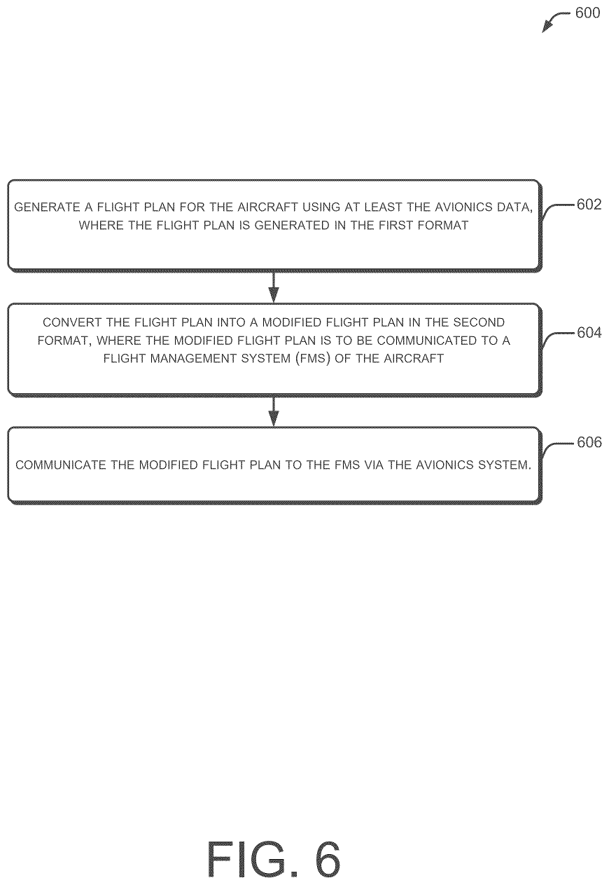

FIGS. 5 and 6 illustrate methods for facilitating advanced avionics functionality in legacy aircrafts, in accordance with examples of the present subject matter. The order in which the method steps are described is not intended to be construed as a limitation, and any number of the described method blocks may be combined in any order to implement the methods, or an alternative method. Further, the methods 500 and 600 may be implemented by processing resource or computing device(s) through any suitable hardware, non-transitory machine-readable instructions, or combination thereof.

It may also be understood that methods 500 and 600 may be performed by programmed computing devices, such as the computing device 102. Furthermore, the methods 500 and 600 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 500 and 600 are described below with reference to the computing device 102, as described above; other suitable systems for the execution of these methods may also be utilized. Additionally, implementation of the method is not limited to such examples.

At block 502, a flight data request is created for receiving at least avionics data from an avionics system of an aircraft. The flight data request may be created in a first format. A computing device other than the avionics system may be compliant with the first format, while the avionics system may be compliant with a second format. In an example, the flight data request is created by the generation engine 202.

At block 504, the flight data request is converted into a modified flight data request in the second format. The flight data request may be converted as the flight data request is to be communicated to the avionics system. In an example, the flight data request may be converted by the conversion engine 204.

At block 506, the modified flight data request is communicated to the avionics system. In an example, the modified flight data request may be communicated to the avionics system by the transceiver engine 206.

At block 508, a flight data response is received from the avionics system in response to the modified flight data request. The flight data response may be received in the second format and may comprise at least the requested avionics data. In an example, the flight data response may be received by the transceiver engine 206.

At block 510, the flight data response is converted from the second format into the first format. The conversion of the flight data response from the second format into the first format may allow the computing device to process the received avionics data in its native format.

At block 512, at least the avionics data is utilized during the operation of the aircraft. At least the avionics data may be utilized in various applications, such as flight planning, performance calculations, or other advanced avionics functionalities. The manner in which at least the avionics data is utilized during the operation of the aircraft is described in conjunction with FIG. 6.

In FIG. 6, at block 602, a flight plan for the aircraft is generated using at least the avionics data. The flight plan may be generated in the first format. In an example, the flight plan may be generated by the operations engine 410.

At block 604, the flight plan is converted into a modified flight plan in the second format. The flight plan may be converted as the modified flight plan is to be communicated to an FMS of the aircraft. In an example, the flight plan may be converted by the conversion engine 204.

At block 606, the modified flight plan is communicated to the FMS via the avionics system. The modified flight plan may be communicated to the FMS via the avionics system by the transceiver engine 206.

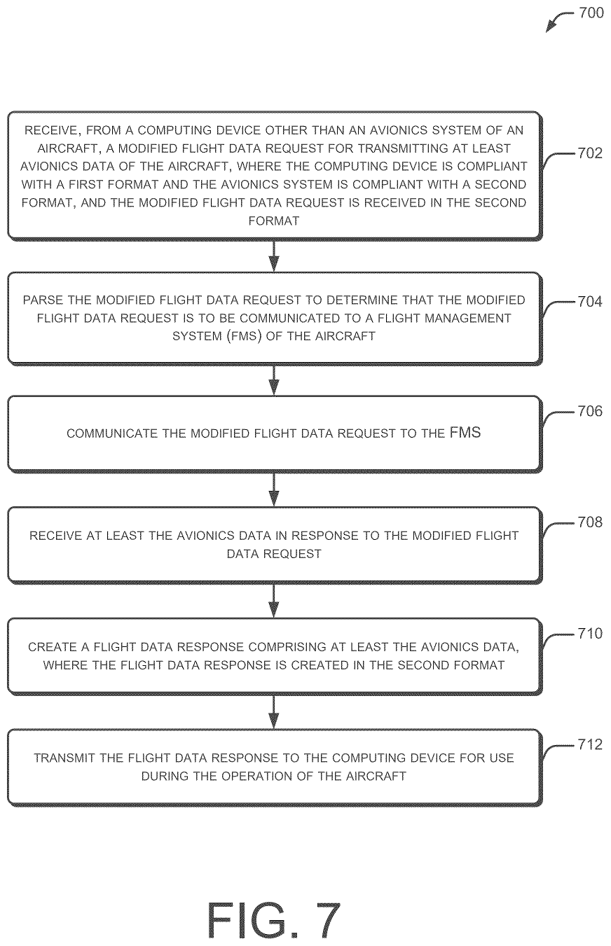

FIGS. 7, 8, and 9 illustrate methods for facilitating advanced avionics functionality in legacy aircrafts, in accordance with other examples of the present subject matter. The order in which the method steps are described is not intended to be construed as a limitation, and any number of the described method blocks may be combined in any order to implement the methods, or an alternative method. Further, the methods 700, 800, and 900 may be implemented by processing resource or computing device(s) through any suitable hardware, non-transitory machine-readable instructions, or combination thereof.

It may also be understood that methods 700, 800, and 900 may be performed by programmed computing devices, such as the ACS 108. Furthermore, the methods 700, 800, and 900 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 700, 800, and 900 are described below with reference to the ACS 108, as described above; other suitable systems for the execution of these methods may also be utilized. Additionally, implementation of the method is not limited to such examples.

At block 702, a modified flight data request is received from a computing device other than an avionics system of an aircraft. The modified flight data request may be for transmitting at least avionics data of the aircraft. The computing device may be compliant with a first format and the avionics system may be compliant with a second format. The modified flight data request may be received in the second format. In an example, the modified flight data request may be received by the communication engine 302.

At block 704, the modified flight data request is parsed to determine that the modified flight data request is to be communicated to an FMS of the aircraft. In an example, the modified flight data request may be parsed by the analysis engine 304.

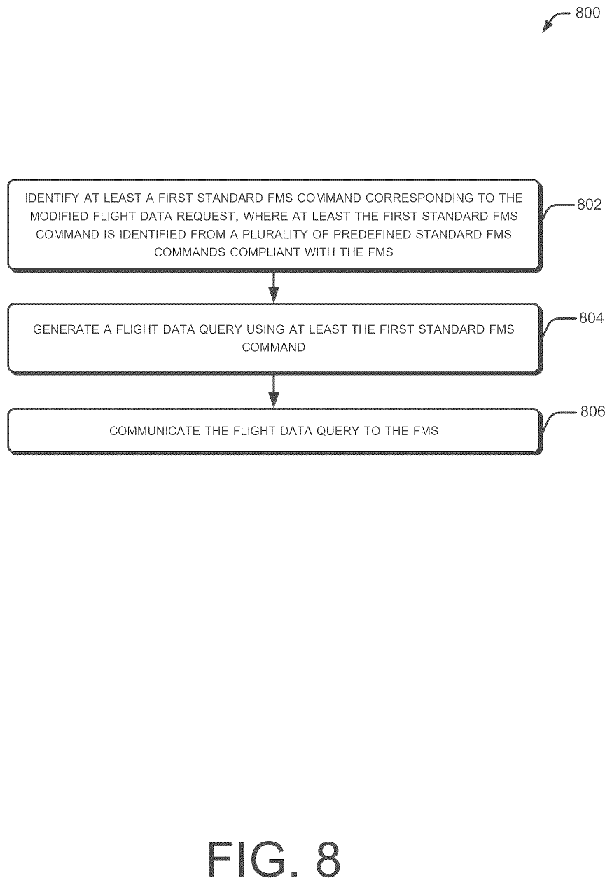

At block 706, the modified flight data request is communicated to the FMS. In an example, the modified flight data request may be communicated to the FMS by the data processing engine 306. The manner in which the modified flight data request is communicated to the FMS is further described in conjunction with the FIG. 8.

At block 708, at least the avionics data is received in response to the modified flight data request. In an example, at least the avionics data may be received by the data processing engine 306.

At block 710, a flight data response including at least the avionics data is created. The flight data response may be created in the second format. In an example, the flight data response may be created by the data processing engine 306.

At block 712, the flight data response is transmitted to the computing device for use during the operation of the aircraft. In an example, the flight data response may be transmitted by the data processing engine 306.

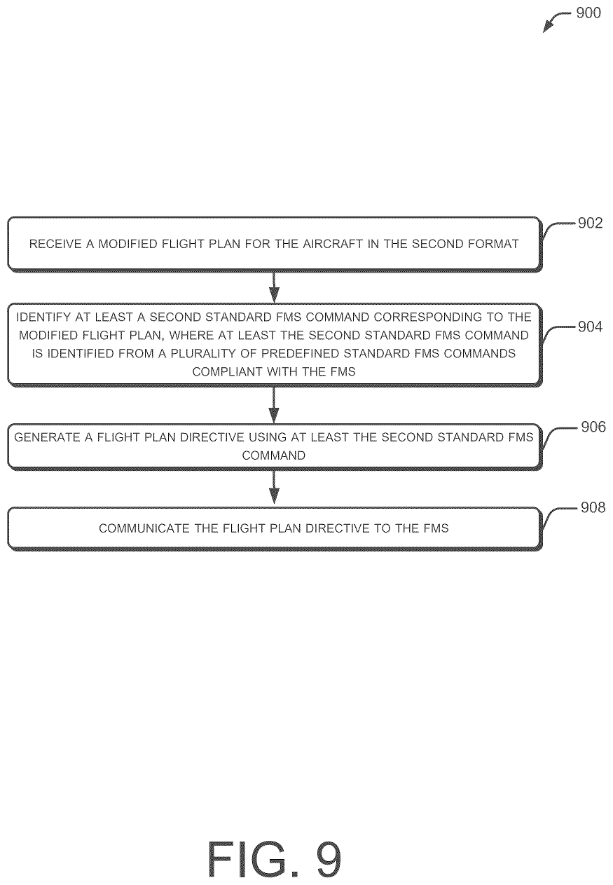

In an example, at least the avionics data may be utilized to generate a flight plan for the aircraft. In the example, the flight plan may be generated in the first format. It may then be determined that the flight plan is to be transmitted to the avionics system, such as the CMU, complaint with the second format. Accordingly, the flight plan may be converted into a modified flight plan in the second format and transmitted to the ACS via the avionics system. Subsequently, the modified flight plan may be received on the ACS and communicated to the FMS. The manner in which the modified plan is communicated to the FMS is described in conjunction with FIG. 9.

In FIG. 8, at block 802, at least a first standard FMS command corresponding to the modified flight data request is identified. At least the first standard FMS command may be identified from a plurality of predefined standard FMS commands compliant with the FMS. In an example, at least the first standard FMS command may be identified by the data processing engine 306.

At block 804, a flight data query is generated using at least the first standard FMS command. In an example, the flight data query may be generated by the data processing engine 306.

At block 806, the flight data query is communicated to the FMS. The flight data query may be communicated to the FMS by the data processing engine 306.

In FIG. 9, at block 902, a modified flight plan for the aircraft is received in the second format. In an example, the modified flight plan may be received by the communication engine 302.

At block 904, at least a second standard FMS command corresponding to the modified flight plan is identified. At least the second standard FMS command may be identified from a plurality of predefined standard FMS commands compliant with the FMS. In an example, at least the second standard FMS command may be identified by the data processing engine 306.

At block 906, a flight plan directive is generated using at least the second standard FMS command. In an example, the flight plan directive may be generated by the data processing engine 306.

At block 908, the flight plan directive is communicated to the FMS. The flight plan directive may be communicated to the FMS by the data processing engine 306. In an example, the flight plan directive may be utilized at the FMS for managing operations of the aircraft.

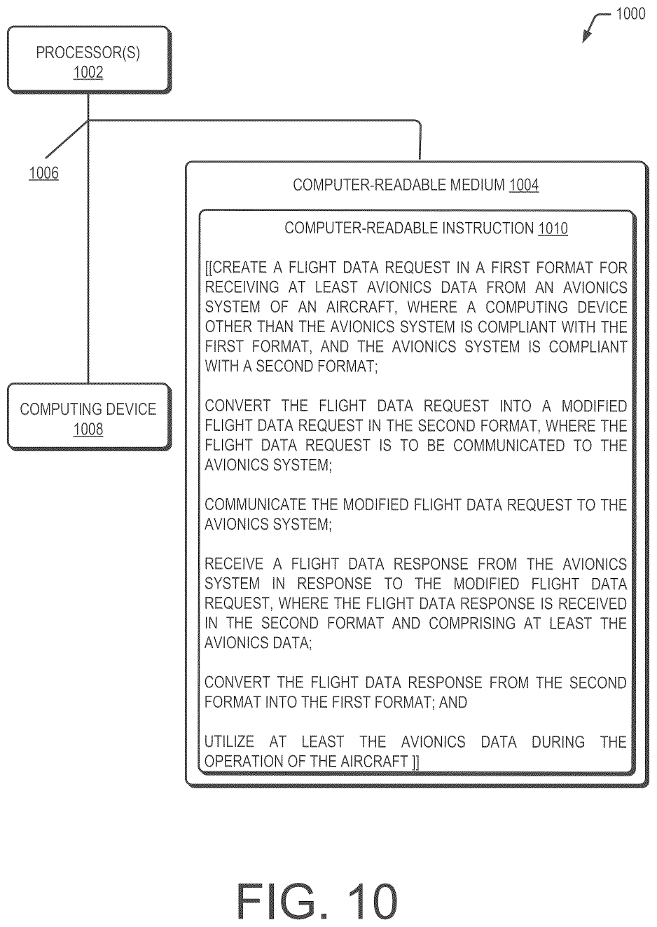

FIG. 10 illustrates a non-transitory computer-readable medium for facilitating advanced avionics functionality in legacy aircrafts, in accordance with an example of the present subject matter.

In an example, the computing environment 1000 includes processor 1002 communicatively coupled to a non-transitory computer readable medium 1004 through communication link 1006. In an example implementation, the computing environment 1000 may be for example, the computing device 102. In an example, the processor 1002 may have one or more processing resources for fetching and executing computer-readable instructions from the non-transitory computer readable medium 1004. The processor 1002 and the non-transitory computer readable medium 1004 may be implemented, for example, in the computing device 102.

The non-transitory computer readable medium 1004 may be, for example, an internal memory device or an external memory. In an example implementation, the communication link 1006 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer readable medium 1004 includes a set of computer readable instructions 1010 which may be accessed by the processor 1002 through the communication link 1006 and subsequently executed for facilitating advanced avionics functionality in the legacy aircrafts. The processor(s) 1002 and the non-transitory computer readable medium 1004 may also be communicatively coupled to a computing device 1008 over the network.

Referring to FIG. 10, in an example, the non-transitory computer readable medium 1004 includes computer readable instructions 1010 that cause the processor 1002 to create a flight data request in a first format for receiving at least avionics data from an avionics system of an aircraft. A computing device other than the avionics system may be compliant with the first format and the avionics system may be compliant with a second format. In an example, the second format may correspond to ARINC 619 protocol. In the example, the avionics system may be the CMU of the aircraft. Further, the flight data request may include at least one first data packet.

The instructions 1010 may then cause the processor 1002 to convert the flight data request into a modified flight data request in the second format, where the flight data request is to be communicated to the avionics system. To convert the flight data request into the modified flight data request, the 1010 may then cause the processor 1002 to modify a source field in a header of the at least one first data packet to include an identifier of the computing device.

The instructions 1010 may then cause the processor 1002 to communicate the modified flight data request to the avionics system. The instructions 1010 may then cause the processor 1002 to receive a flight data response from the avionics system in response to the modified flight data request. The flight data response may be received in the second format and may include at least the avionics data.

The instructions 1010 may then cause the processor 1002 to convert the flight data response from the second format into the first format. The instructions 1010 may then cause the processor 1002 to utilize at least the avionics data during the operation of the aircraft.

To utilize at least the avionics data during the operation of the aircraft, the instructions 1010 may then cause the processor 1002 to generate a flight plan for the aircraft using at least the avionics data. The flight plan may be generated in the first format. Further, the flight plan comprises at least one second data packet.

The instructions 1010 may then cause the processor 1002 to convert the flight plan into a modified flight plan in the second format, where the modified flight plan is to be communicated to an FMS of the aircraft. To convert the flight plan into the modified flight plan, the instructions 1010 may cause the processor 1002 to modify a source field in a header of the at least one second data packet to include an identifier of the computing device. The instructions 1010 may then cause the processor 1002 to communicate the modified flight plan to the FMS via the avionics system.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A method comprising:
creating a flight data request in a first format for receiving at least avionics data from an avionics system of an aircraft, wherein a computing device other than the avionics system is compliant with the first format, and the avionics system is compliant with a second format;
converting the flight data request into a modified flight data request in the second format, wherein the flight data request is to be communicated to the avionics system;
communicating the modified flight data request to the avionics system;
receiving a flight data response from the avionics system in response to the modified flight data request, wherein the flight data response is received in the second format and comprises at least the avionics data;
converting the flight data response from the second format into the first format; and
utilizing at least the avionics data during operation of the aircraft.

2. The method of claim 1, wherein the flight data request comprises at least one first data packet, and converting the flight data request into the modified flight data request comprises modifying a source field in a header of the at least one first data packet to include an identifier of the computing device.

3. The method of claim 1, further comprising:
generating a flight plan for the aircraft using at least the avionics data, wherein the flight plan is generated in the first format;
converting the flight plan into a modified flight plan in the second format, wherein the modified flight plan is to be communicated to a Flight Management System (FMS) of the aircraft; and
communicating the modified flight plan to the FMS via the avionics system.

4. The method of claim 3, wherein the flight plan comprises at least one second data packet, and converting the flight plan into the modified flight plan comprises modifying a source field in a header of the at least one second data packet to include an identifier of the computing device.

5. The method of claim 4, wherein the second format corresponds to Aeronautical Radio Incorporated (ARINC) 619 protocol.

6. The method of claim 5, wherein the avionics system is a Communication Management Unit (CMU) of the aircraft.

7. An Aircraft Connectivity System (ACS) comprising:
a communication engine to receive, from a computing device other than an avionics system of an aircraft, a modified flight data request for transmitting at least avionics data of the aircraft, wherein the computing device is compliant with a first format and the avionics system is compliant with a second format, and the modified flight data request is received in the second format;
an analysis engine coupled to the communication engine to parse the modified flight data request to determine that the modified flight data request is to be communicated to a Flight Management System (FMS) of the aircraft; and
a data processing engine coupled to the analysis engine to:
communicate the modified flight data request to the FMS;
receive at least the avionics data in response to the modified flight data request;
create a flight data response comprising at least the avionics data, wherein the flight data response is created in the second format; and
transmit the flight data response to the computing device for use during operation of the aircraft.

8. The ACS of claim 7, wherein the modified flight data request comprises at least one first data packet, and a source field in a header of the at least one first data packet comprises an identifier of the computing device.

9. The ACS of claim 8, wherein the data processing engine is to transmit the flight data response to the computing device based on the identifier of the computing device.

10. The ACS of claim 7, wherein to communicate the modified flight data request to the FMS, the data processing engine is to:
identify at least a first standard FMS command corresponding to the modified flight data request, wherein at least the first standard FMS command is identified from a plurality of predefined standard FMS commands compliant with the FMS;
generate a flight data query using at least the first standard FMS command; and
communicate the flight data query to the FMS.

11. The ACS of claim 7, wherein:
the communication engine is to receive a modified flight plan for the aircraft in the second format; and
the data processing engine is to:
identify at least a second standard FMS command corresponding to the modified flight plan, wherein at least the second standard FMS command is identified from a plurality of predefined standard FMS commands compliant with the FMS;
generate a flight plan directive using at least the second standard FMS command; and
communicate the flight plan directive to the FMS.

12. The ACS of claim 11, wherein the modified flight plan comprises at least one second data packet and a source field in a header of the at least one second data packet comprises an identifier of the computing device.

13. The ACS of claim 12, wherein the data processing engine is to transmit a flight plan directive acknowledgement to the computing device based on the identifier of the computing device, and the flight plan directive acknowledgement is indicative of successful upload of the flight plan directive onto the FMS.

14. The ACS of claim 7, wherein the second format corresponds to Aeronautical Radio Incorporated (ARINC) 619 protocol.

15. A non-transitory computer readable medium comprising computer-readable instructions that when executed cause a processing resource of a computing device to:
create a flight data request in a first format for receiving at least avionics data from an avionics system of an aircraft, wherein a computing device other than the avionics system is compliant with the first format, and the avionics system is compliant with a second format;
convert the flight data request into a modified flight data request in the second format, wherein the flight data request is to be communicated to the avionics system;
communicate the modified flight data request to the avionics system;
receive a flight data response from the avionics system in response to the modified flight data request, wherein the flight data response is received in the second format and comprising at least the avionics data;
convert the flight data response from the second format into the first format; and
utilize at least the avionics data during operation of the aircraft.

16. The non-transitory computer readable medium of claim 15, wherein the flight data request comprises at least one first data packet, and to convert the flight data request into the modified flight data request, the instructions cause the processing resource to modify a source field in a header of the at least one first data packet to include an identifier of the computing device.

17. The non-transitory computer readable medium of claim 15, wherein the instructions further cause the processing resource to:
generate a flight plan for the aircraft using at least the avionics data, wherein the flight plan is generated in the first format;
convert the flight plan into a modified flight plan in the second format, wherein the modified flight plan is to be communicated to a Flight Management System (FMS) of the aircraft; and
communicate the modified flight plan to the FMS via the avionics system.

18. The non-transitory computer readable medium of claim 17, wherein the flight plan comprises at least one second data packet, and to convert the flight plan into the modified flight plan, the instructions cause the processing resource to modify a source field in a header of the at least one second data packet to include an identifier of the computing device.

19. The non-transitory computer readable medium of claim 18, wherein the second format corresponds to Aeronautical Radio Incorporated (ARINC) 619 protocol.

20. The non-transitory computer readable medium of claim 15, wherein the avionics system is a Communication Management Unit (CMU) of the aircraft.
